(19) United States
(12) Patent Application Publication
(10) Pub. No.: US 2025/0363526 A1
(43) Pub. Date: Nov. 27, 2025

(54) PERSONALIZED PRESENTATION OF CONTENT BASED ON LOCATION DATA CAPTURED FROM SMART CART SYSTEMS

(71) Applicant: Maplebear Inc., San Francisco, CA (US)

(72) Inventors: David McIntosh, San Francisco, CA (US); Dominic Cocchiarella, Berkeley, CA (US); Anirban Kundu, Danville, CA (US)

(21) Appl. No.: 19/217,899

(22) Filed: May 23, 2025

Related U.S. Application Data
(60) Provisional application No. 63/651,314, filed on May 23, 2024.
(60) Provisional application No. 63/651,836, filed on May 24, 2024.

(51) Int. Cl. G06Q 30/0251; G06F 40/20; G06Q 30/0601

(52) U.S. Cl. CPC G06Q 30/0271; G06F 40/20; G06Q 30/0261; G06Q 30/0639; G06Q 30/0643

(57) ABSTRACT

A system stores content items at a content data store, each content item corresponding to an item within an environment. The system accesses location data captured by a plurality of location sensors in the environment, each coupled to a smart cart system located within the environment. The location data indicates a current location of a corresponding smart cart system. The system computes a number of smart cart systems within a threshold area around a display screen within the environment based on the location data. The system computes a presentation score for each of the content items by combining a context relevance score and a personal relevance score weighted based on a personalization weighting. The system selects a subset of the content items for display based on the presentation scores and causes the display screen to present the subset of content items.

### CROSS REFERENCE TO RELATED APPLICATIONS

This application claims the benefit of U.S. Provisional Patent Applications Nos. 63/651,314, filed May 23, 2024, and 63/651,836, filed May 24, 2024, each of which is incorporated by reference in its entirety.

### BACKGROUND

Conventional systems may use interactions made by users with content presented at a device to display further content to the users at the devices. These systems leverage feedback captured on an individual level (e.g., for each individual device) or in association with connected devices associated with an individual user. However, these interactions are typically digital, and these conventional systems do not include additional devices located within an environment that is configured to capture sensor data, such as image data, location data, and the like. Thus, the conventional systems lack the ability to leverage sensor data captured at different devices within an environment to determine actions and preferences of users.

Further, these systems focus on selecting content to display to a particular user—e.g., the user of an individual device or set of devices. However, this is not useful when a display screen is presenting content in an environment that users are moving around in, thus changing their ability to view the display screen. Traditional approaches for dynamically selecting content for presentation to a user are generally based on a single user viewing content on a single device, which is a state that these approaches can assume in selecting content. However, in the display screen context, traditional techniques cannot sufficiently identify users who are viewing the screens, which means that these techniques for dynamically selecting content are ineffective.

### SUMMARY

In accordance with one or more aspects of the disclosure, a system personalizes content displayed on display screens within an environment based on location sensor data captured from smart shopping carts near the display screens. More particularly, an environment of items may include screens that display content about one or more items to users traversing the environment. A system that communicates with smart shopping carts may access locations of the smart shopping carts in the environment and may identify users associated with the shopping carts that are within a threshold area of one of the screens. The system determines presentation scores for content items based on the users that are within the threshold area and causes the screen to display content about a content item with a highest presentation score.

In accordance with one or more embodiments, the system stores a plurality of content items at a content data store. Each of the plurality of content items corresponds to an item within an environment. The system accesses location data captured by a plurality of location sensors in the environment. Each of the location sensors is coupled to one of a plurality of smart cart systems located within the environment, and the location data from a location sensor indicates a current location of a corresponding smart cart system. The system computes a number of smart cart systems within an area around a display screen within the environment based on the location data. The system computes a presentation score for each of the plurality of content items by combining a context relevance score and a personal relevance score weighted based on a personalization weighting. The context relevance score is a metric representing demographics of the environment, and the demographics include items within a threshold distance of the display and a current time. The personal relevance score is a metric describing user information about the smart cart systems within the designated area, and the personalization weighting is a function of the number of users within the designated area. The system selects a subset of the content items for display on the display screen based on the presentation scores of the plurality of content items and causes the display screen to present the selected set of content items.

By leveraging location data captured by sensors of smart shopping carts used by users in the environment, the system improves on the technical field of generating computer models of real-world activities and automatic customization of content for users. In particular, the location data captured by the smart shopping carts provides otherwise unavailable information on which users are near a display screen, which enables the customization of content to those users.

### BRIEF DESCRIPTION OF DRAWINGS

FIG. 1 illustrates an example environment of a smart cart system, in accordance with one or more illustrative embodiments.

FIG. 2 is a block diagram illustrating components of a remote system, in accordance with one or more embodiments.

FIG. 3 is a block diagram illustrating a display screen in an item storage environment, in accordance with one or more illustrative embodiments.

FIG. 4 is a flowchart illustrating a method for causing a device to display content items, in accordance with one or more embodiments.

### DETAILED DESCRIPTION

### Example System Environment for Smart Cart System

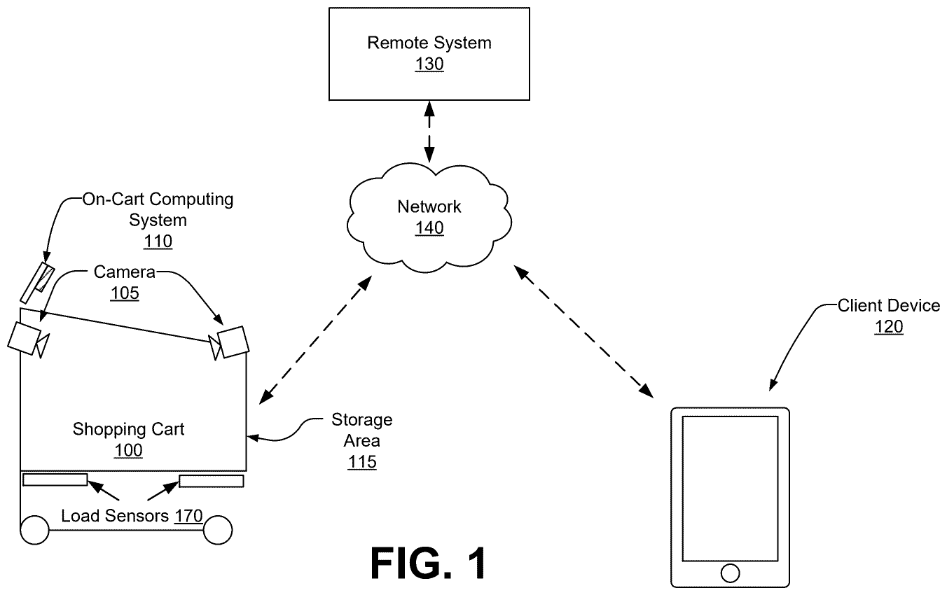

FIG. 1 illustrates an example system environment for a smart cart system, in accordance with one or more illustrative embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves—the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 apply a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and charges the user for the cost of the items in the cart. The remote system 130 may communicate with other systems to execute the transaction, such as a computing system of the retailer or of a financial institution. The remote system 130 may receive payment information from the shopping cart 100 and uses that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

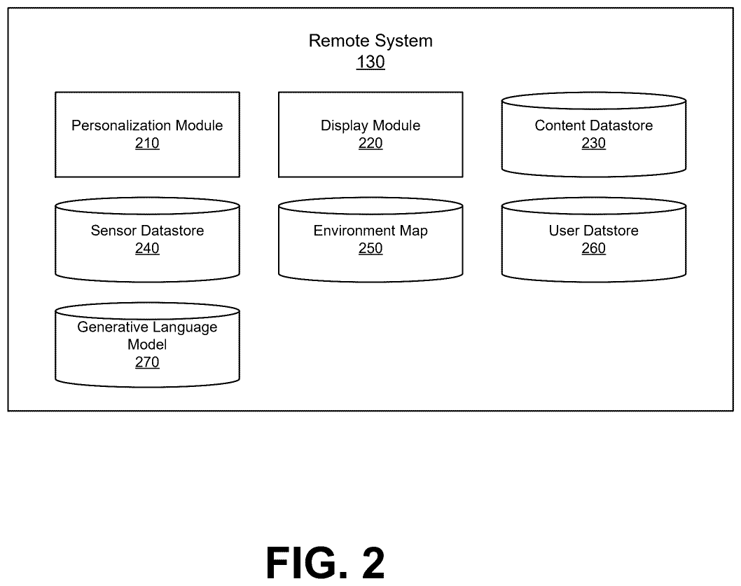

FIG. 2 is a block diagram illustrating components of a remote system 130, in accordance with one or more embodiments. The remote system 130 includes a personalization module 210, display module 220, content datastore 230, sensor datastore 240, environment map 250, user datastore 260, and machine-learning model 270. In some embodiments, the remote system 130 includes additional or alternative components to those shown in FIG. 2.

The personalization module 210 determines presentation scores for content items. Each presentation score is indicative of a level of personalization associated with the content item based on users who are within a threshold area of a display screen. The personalization module 210 may access content items via the network 140 from one or more external systems. Each content item may be associated with an item within an environment of a shopping cart 100. The personalization module 210 stores content items in the content datastore 230.

The personalization module 210 may receive a request to generate content to present at a display screen. The indication may include an identifier of the display screen and a current time. The personalization module 210 accesses location data captured by a plurality of location sensors in the environment. The personalization module 210 may access the location data from location sensors in the environment or the sensor datastore 240. Each location sensor may be coupled to a smart cart system (e.g., shopping cart 100) and may capture a location of a respective smart cart system at a timestamp. The personalization module 210 accesses the environment map 250, which includes locations of one or more display screens. Each display screen may be associated with a threshold area around or near the display screen. The personalization module 210 computes a number of smart cart systems that are within the threshold area associated with the display screen, which the personalization module 210 uses to approximate the number of users within the threshold area. In some embodiments, the personalization module 210 also includes client devices 120 within the threshold area in the computed number.

The personalization module 210 computes a presentation score for each of the plurality of content items in the content datastore 230 based on the computed number. The presentation score for each item may be a combination of a context relevance score and a personal relevance score weighted with on a personalization weighting. The context relevance score is a metric representing demographics of the environment. The demographics may include items that are within a threshold distance of the display screen and a current time of day (e.g., opening hour in the morning, closing hour in the evening, lunch hour around noon, etc.). The personalization module 210 may determine the number of items within a threshold distance of the display screen using the environment map 250, which the personalization module 210 may weight according to the current time of day to compute the context relevance score. For example, opening hour may be associated with low traffic in the environment (e.g., determined based on sensor data of locations of shopping carts 100) lower weighting than for lunch hour, which lunch hour may be associated with high traffic in the environment.

The personal relevance score is a metric describing user information associated with the smart cart systems determined to be located within the threshold area of the identified display screen. The personalization module 210 may access user data associated with each smart cart system from the smart cart systems themselves or the user datastore 260. The user data of a smart cart system may be associated with a user account of a user of the smart cart system and include previous interactions with items made by the user via a display on a smart cart system or at a client device 120 and items previously obtained by the user from the environment.

In some embodiments, the personal relevance score is a combination of a plurality of user personal relevance scores. The personalization module 210 may calculate each user's personal relevance score by computing a distance between a user embedding and each content item embedding. The user embedding may be representative of the user data associated with a particular user. For each user associated with a smart cart system within the threshold area, the personalization module 210 may compute the distance between the user embedding and each content item embedding and combine the computed distances together (e.g., by averaging, summing, etc.) to compute the user personal relevance score of the respective user. The personalization module 210 may combine each user's personal relevance score associated with users within the threshold area (as determined based on the location of their respective smart cart systems) by summing, averaging, or otherwise combining the user personal relevance scores, resulting in a personal relevance score for the display screen.

The personalization module 210 may weight the personal relevance score by a personalization weighting. The personalization weighting is a function of the number of users within the threshold area. In some embodiments, the personalization weighting is the number of users within the threshold area. In some embodiments, the personalization weighting is zero in response to the number of users within the threshold area exceeding a personalization threshold. For each content item, the personalization module 210 combines the personal relevance score with the context relevance score, such as by summing, multiplying, or otherwise combining the personal relevance score and context relevance score. The personalization module 210 selects a subset of the content items from the content datastore 230 based on the presentation scores. The personalization module 210 may select the content item with the highest presentation score, may select content items with presentation scores above a threshold score, or may select content items with a top percentage of the presentation scores (for example, the ten highest scores).

In some embodiments, the presentation score inputs a prompt including a request for a set of content and the presentation scores to the generative language model 270, which provides the subset of content items to the personalization module 210. The personalization module 210 may tune the generative language model 270 on interaction data from the content datastore 230. The interaction data includes sets of content items presented at each display screen and a time period each set was presented. Each content item in the sets may be associated with an item and a presentation score for the item and labeled with interactions with the item made by one or more users within a time period of presentation of the set of content. The interactions may include the user interacting with the display screen presenting the content item, the user picking up the content item (determined based on image data captured in the environment), the user adding the item to their order via a client device 120, and the like.

The display module 220 causes the display screens in the environment to present selected sets of content items. The display module 220 may be configured to request generation of a new set of content for one or more display screens. The display module 220 may request the new sets of content at set time intervals, in response to receiving a request from an external operator, or in response to determining a user has entered or exited a threshold area. The display module 220 sends the requests to the personalization module 210 and receives a set of content items for each request. The display module 220 sends the set of content items for display at a display screen associated with the request.

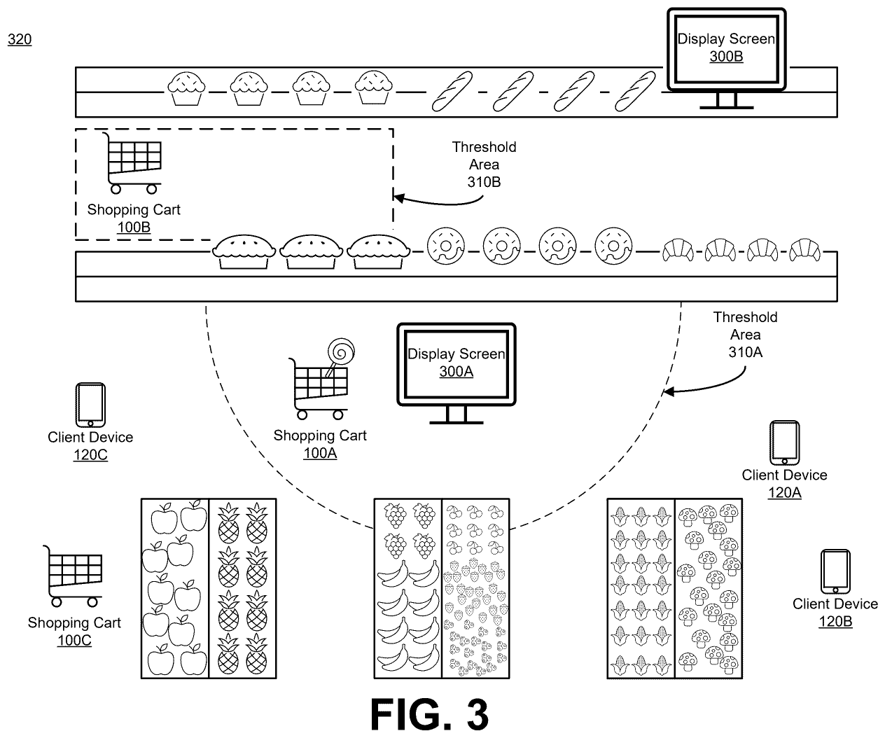

FIG. 3 is a block diagram illustrating display screens 300 in an item storage environment 320, in accordance with one or more illustrative embodiments. Each display screen 300 is associated with a threshold area 310. The threshold areas may be around or near associated display screens and may be of different shapes. For instance, display screen 300A is associated with threshold area 310A, which is shaped in a semicircle that spans outward from display screen 300A towards a fruits and vegetables section of the item storage environment 320 but is cut off by the aisle of baked goods. Display screen 300B is associated with threshold area 310B, which is down the aisle of baked goods from display screen 300B and is shaped like a rectangle.

The remote system 130 may determine content to display at each display screen 300 based on the shopping carts 100 and client devices 120 that come within the threshold areas 310. For instance, the remote system 130 may determine a first presentation score for display screen 300A based on the user of shopping cart 100A being within threshold area 310A and a second presentation score for display screen 300BN based on the user of shopping cart 100B being within threshold area 310B. The remote system 130 may select sets of content for present at each display screen 300 based on the presentation scores. The remote system 130 may update the first presentation score based on shopping cart 100A leaving threshold area 310A or another shopping cart 100C or client device 120 entering threshold area 310A. The remote system 130 may update the second presentation score based on shopping cart 100B leaving threshold area 310B or another shopping cart 100C or client device 120 entering threshold area 310B.

### Example Method

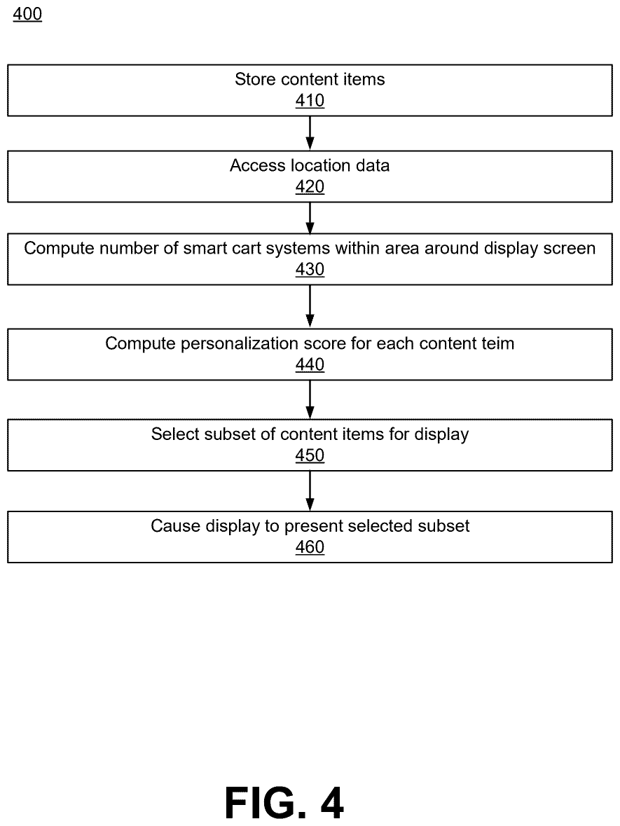

FIG. 4 is a flowchart illustrating a method 400 for causing a device to display content items, in accordance with one or more embodiments. The following is described in relation to the remote system 130, but in some embodiments, additional or alternative components may perform the steps of method 400. In some embodiments, additional or alternative steps to those described in relation to FIG. 4 may be used for method 400.

The personalization module 210 stores 410 a plurality of content items at a content datastore 230. Each of the plurality of content items corresponds to an item within an environment. The personalization module 210 accesses 420 location data captured by a plurality of location sensors in the environment. Each location sensor may be affixed to one of a plurality of smart cart systems located within the environment, and the location data from each location sensor may indicate a current location of a corresponding smart cart system. The personalization module 210 computes 430 a number of smart cart systems within a threshold area 310 around a display screen 300 within the environment based on the location data.

The personalization module 210 computes 440 a presentation score for each of the plurality of content items by combining a context relevance score and a personal relevance score weighted based on a personalization weighting. The context relevance score is a metric representing demographics of the environment. The demographics include items within a threshold distance of the display and a current time. In some embodiments, the threshold distance is representative of the distance the threshold area spans. The personal relevance score is a metric describing user information about the smart cart systems within the threshold area, and the personalization weighting is a function of the number of users within the threshold area. The personalization module 210 selects 450 a subset of the content items from content datastore 230 for display on the display screen based on the presentation scores of the plurality of content items and sends the subset of content items to the display module 220. The display module 220 causes 460 the display screen to present the selected subset of content items.

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising:
storing a plurality of content items at a content data store, wherein each of the plurality of content items corresponds to an item within an environment;
accessing location data captured by a plurality of location sensors in the environment, wherein each of the location sensors is coupled to one of a plurality of smart cart systems located within the environment, the location data from a location sensor indicating a current location of a corresponding smart cart system;
identifying, based on the location data, a number of smart cart systems within an area around a display screen within the environment;
generating a presentation score for each of the plurality of content items by:
generating a context relevance score based on demographics of the environment, wherein the demographics include items within a threshold distance of the display screen and a current time;
generating a personal relevance score based on user information associated with the smart cart systems within the threshold area; and
generating a personalization weighting for the personal relevance score based on the number of users within the threshold area; and
generating the presentation score for the content item by combining the context relevance score and a personal relevance score weighted based on the personalization weighting;
selecting a subset of the content items for display on the display screen based on the presentation scores of the plurality of content items; and
causing the display screen to present the selected subset of content items.

2. The method of claim 1, wherein generating the personal relevance score comprises generating a combination of a plurality of user personal relevance scores.

3. The method of claim 2, further comprising:
generating each user personal relevance score by computing a distance between a user embedding and at least one content item embedding.

4. The method of claim 1, wherein selecting the subset of the content items for display comprises:
inputting, to a generative language model, a prompt including a request for the subset of content items and the presentation scores; and
receiving, from the generative language model, the subset of content items.

5. The method of claim 4, the method further comprising:
tuning the generative language model on interaction data, wherein the interaction data includes sets of content presented at the display screen, each content item associated with an item and a presentation score for the item and labeled with interactions with the item made by one or more users within a period of time of presentation of the subset of content items.

6. The method of claim 1, the method further comprising:
setting the personalization weighting to zero in response to the number of users within the threshold area exceeding a personalization threshold.

7. The method of claim 1, the method further comprising:
capturing location data by location sensors at each of a set of client devices and a set of shopping carts; and
identifying the location based on the location data.

8. The method of claim 1, the method further comprising:
configuring the display to request, at set time intervals, generation of a new subset of content items.

9. The method of claim 1, the method further comprising:
configuring the display to request generation of a new subset of content items in response to the number of users within the threshold area changing by a threshold amount.

10. A non-transitory computer-readable storage medium storing instructions that, when executed, cause a processor to perform steps comprising:
storing a plurality of content items at a content data store, wherein each of the plurality of content items corresponds to an item within an environment;
accessing location data captured by a plurality of location sensors in the environment, wherein each of the location sensors is coupled to one of a plurality of smart cart systems located within the environment, the location data from a location sensor indicating a current location of a corresponding smart cart system;
identifying, based on the location data, a number of smart cart systems within an area around a display screen within the environment;
generating a presentation score for each of the plurality of content items by:
generating a context relevance score based on demographics of the environment, wherein the demographics include items within a threshold distance of the display screen and a current time;
generating a personal relevance score based on user information associated with the smart cart systems within the threshold area; and
generating a personalization weighting for the personal relevance score based on the number of users within the threshold area; and
generating the presentation score for the content item by combining the context relevance score and a personal relevance score weighted based on the personalization weighting;
selecting a subset of the content items for display on the display screen based on the presentation scores of the plurality of content items; and
causing the display screen to present the selected subset of content items.

11. The non-transitory computer-readable storage medium of claim 10, wherein generating the personal relevance score comprises generating a combination of a plurality of user personal relevance scores.

12. The non-transitory computer-readable storage medium of claim 11, the steps further comprising:
generating each user personal relevance score by generating a distance between a user embedding and at least one content item embedding.

13. The non-transitory computer-readable storage medium of claim 10, wherein selecting the subset of the content items for display comprises:
inputting, to a generative language model, a prompt including a request for the subset of content items and the presentation scores; and
receiving, from the generative language model, the subset of content items.

14. The non-transitory computer-readable storage medium of claim 13, the steps further comprising:
tuning the generative language model on interaction data, wherein the interaction data includes sets of content presented at the display screen, each content item is associated with an item and a presentation score for the item and labeled with interactions with the item made by one or more users within a period of time of presentation of the subset of content items.

15. The non-transitory computer-readable storage medium of claim 10, the steps further comprising:
setting the personalization weighting to zero in response to the number of users within the threshold area exceeding a personalization threshold.

16. The non-transitory computer-readable storage medium of claim 10, the steps further comprising:
capturing location data by location sensors at each of a set of client devices and a set of shopping carts; and
determining the location based on the location data.

17. The non-transitory computer-readable storage medium of claim 10, the steps further comprising:
configuring the display to request, at set time intervals, a generation of a new subset of content items.

18. The non-transitory computer-readable storage medium of claim 10, the steps further comprising:
configuring the display to request generation of a new subset of content in response to the number of users within the threshold area changing by a threshold amount.

19. A system comprising:
a processor; and
a non-transitory computer-readable storage medium storing instructions that, when executed, cause a processor to perform steps comprising:
storing a plurality of content items at a content data store, wherein each of the plurality of content items corresponds to an item within an environment;
accessing location data captured by a plurality of location sensors in the environment, wherein each of the location sensors is coupled to one of a plurality of smart cart systems located within the environment, the location data from a location sensor indicating a current location of a corresponding smart cart system;
identifying, based on the location data, a number of smart cart systems within an area around a display screen within the environment;
generating a presentation score for each of the plurality of content items by:
generating a context relevance score based on demographics of the environment, wherein the demographics include items within a threshold distance of the display screen and a current time;
generating a personal relevance score based on user information associated with the smart cart systems within the threshold area; and
generating a personalization weighting for the personal relevance score based on the number of users within the threshold area; and
generating the presentation score for the content item by combining the context relevance score and a personal relevance score weighted based on the personalization weighting;
selecting a subset of the content items for display on the display screen based on the presentation scores of the plurality of content items; and
causing the display screen to present the selected subset of content items.

20. The system of claim 19, wherein selecting the subset of the content items for display comprises:
inputting, to a generative language model, a prompt including a request for a subset of content items and the presentation scores; and
receiving, from the generative language model the subset of content items.
